(19) United States
(12) Patent Application Publication
(10) Pub. No.: US 2016/0042587 A1
(43) Pub. Date: Feb. 11, 2016

(54) Personal Identification Card for Lottery Participant

(71) Applicant: Guido Federico, Dollard-des-Ormeaux (CA)

(72) Inventor: Guido Federico, Dollard-des-Ormeaux (CA)

(21) Appl. No.: 14/455,889

(22) Filed: Aug. 9, 2014

(51) Int. Cl. G07F 17/32

(52) U.S. Cl. CPC G07F 17/329; G07F 17/3225

(57) ABSTRACT

As a means to eliminate winning-lottery-ticket theft and to ensure the prizes are awarded to the legitimate winner, a Lottery Corporation, or any third party entity (hereinafter known as ‘The Issuer’), would provide a Personal Identification Card (PIC) to lottery participants. In coordination with a computerized database, the PIC would provide accurate identification of ticket owners and therefore the rightful recipients of any potential winnings. Such identification would effectively stop winning-lottery-ticket theft, misidentification of the rightful winner, money laundering associated with winning lottery tickets, etc.

Lottery participants would apply for a PIC, a process completed online or in-person through a registered lottery ticket retailer. The participant would provide personal identification (i.e. name, address, date of birth, phone number, password, security questions, etc.) and any other information critical to positively identify an individual in the event that evidence is required to prove legitimate ownership of a winning ticket. This information, being confidential, would be retained on file by the Issuer. The Issuer would then provide a PIC, bearing a magnetic strip, an embedded chip or a unique alphanumerical combination, which would identify the card's owner.

At the time of purchase, a ticket buyer would offer his PIC to the retailer who would scan it either before or after scanning the tickets the customer is purchasing, effectively registering all of the tickets under the buyer's PIC number. This information is transmitted to the Issuer's database electronically and retained on record. Tickets bought under the PIC system would be clearly identified and labelled as such, making the ticket-owner identifiable, thereby discouraging theft as the tickets are rendered worthless, except to the rightful owner. The name and identifying information of the ticket buyer may appear on the ticket. It would no longer be necessary to sign lottery tickets when purchased under the personal identification system.

Only the PIC holder would be able to collect any winnings by having his PIC and ticket scanned. If the ticket is scanned under the same personal identification card number as when it was bought, it would be a match, proving without any doubt legitimate ownership of the ticket. Should one lose either the ticket and/or the personal identification card, the rightful owner would still be able to confirm ownership of the winning ticket simply by visiting the Issuer's offices and confirming the personal information retained in one's file. Should one acquire someone else's winning ticket and matching personal identification card that are not rightfully his, an interrogation at the Issuer's offices could still be performed in order to identify the ticket's rightful owner.

1. The personal identification system may offer other services, such as a personal identification account, where the lottery player may make deposits or link a credit card to the account and would buy tickets online. Any winnings may be deposited in this account, or into the player's personal bank account through direct deposit, if the player so chooses. Furthermore, should the lottery player unknowingly hold a winning ticket, the Issuer will verify the winning ticket and notify the corresponding lottery player¹.
¹“There were nearly $40 billion in prizes awarded in U.S. lotteries last year, and about $800 million in winnings weren't collected, according to Chuck Strutt, executive director of the Multi-State Lottery Association.”—http://qqq.kzly.xom/nwqa/monwy/—800-million-in-lottery-prizes-go-unclaimed/-/116108/17580012/-/a5lrm1z/-/index.html
Should the Issuer be a Lottery Corporation, the personal identification system will reduce expenses and increase revenue. Lottery Corporations would save millions of dollars every year in commissions to retailers², as well as fees and expenses associated with proper lottery-winner identification. At the Issuer's discretion, the personal identification system can be offered at a fee (i.e.: pay-as-you-play, monthly, annual, etc.), which would create a potentially renewable source of revenue, as well as provide an invaluable survey of the ticket-buying segment of the population. The personal identification system would also stop money laundering associated with winning tickets, as only legitimate owners of tickets can claim the prize. Personal identification tickets cannot be donated or sold and jackpots can only be claimed by owners of a PIC. All winnings will be issued strictly to the PIC holder. As a means to increase ticket sales, the Lottery Corporation may offer bonus prizes to PIC holders.
²“In 2011, more than $4 Billion was paid to 200,000 North American lottery retailers in commissions for selling lottery games”—http://www.naspl.org/
For lottery players participating in a group, all participants would offer their PICs to the individual responsible for purchasing the tickets, who would have all the PICs scanned at the time of purchase. Alternately, all the members of the group could apply for one group PIC for all members. Any winnings would be divided equally and paid to each member individually.
